(19) United States
(12) Patent Application Publication
(10) Pub. No.: US 2011/0123805 A1
(43) Pub. Date: May 26, 2011

(54) a-ALUMINA FOR PRODUCING SINGLE CRYSTAL SAPPHIRE

(75) Inventors: Hirotaka OZAKI, Ehime (JP); Shinji FUJIWARA, Ehime (JP)

(73) Assignee: SUMITOMO CHEMICAL COMPANY, LIMITED, Tokyo (JP)

(21) Appl. No.: 12/949,374

(22) Filed: Nov. 18, 2010

(30) Foreign Application Priority Data
Nov. 20, 2009 (JP) 2009-264776

(51) Int. Cl. B32B 5/16; C01F 7/02

(52) U.S. Cl. 428/402; 423/625

(57) ABSTRACT

Since α-alumina particles have low bulk density, there is such a problem that a production efficiency of single crystal sapphire is not enough. The present invention provides an α-alumina for producing single crystal sapphire, wherein its volume per one α-alumina particle is not less than 0.01 cm³, and its relative density is not less than 80%, and its bulk density of aggregate is in the range of 1.5 to 2.3 g/cm³.

### FIELD OF THE INVENTION

The present invention relates to α-alumina for producing single crystal sapphire.

### BACKGROUND OF THE INVENTION

The α-alumina is useful as a raw material for producing single crystal sapphire. The single crystal sapphire can be produced by pouring the α-alumina in a crucible made of metal molybdenum, heating the α-alumina to melt it, followed by pulling up from a melt (JP-A-5-97569).

It is still desired to provide an α-alumina which can readily produce the single crystal sapphire having no contamination inserted therein, and has a high fluidity to allow a crystal growth to occur without clogging within an apparatus due to fusion bonded α-alumina particles in case that it is used by continuously feeding raw materials into the apparatus which is maintained under a high temperature atmosphere in for example an edge-defined film-fed growth method (hereinafter referred to as EFG method).

Spherical α-alumina particles such as AKQ-10 (manufactured by Sumitomo Chemical Co., Ltd.) are well known as particles that are made of α-alumina having no contamination inserted therein, and have such a high fluidity.

### SUMMARY OF THE INVENTION

However, since such α-alumina particles have low bulk density, there is such a problem that a production efficiency of single crystal sapphire is not enough.

Therefore, an object of the present application is to provide α-alumina which can efficiently produce the single crystal sapphire.

The present inventors have performed diligent research in order to develop α-alumina particles which can allow the single crystal sapphire to be efficiently produced, thus completing the present invention.

The present invention provides an α-alumina for producing single crystal sapphire, wherein its volume per one α-alumina particle is not less than 0.01 cm³, and its relative density is not less than 80%, and its bulk density of aggregate is in the range of 1.5 to 2.3 g/cm³.

Since in the α-alumina for producing single crystal sapphire according to the present invention, its volume per one α-alumina particle is not less than 0.01 cm³, and its relative density is not less than 80%, and its bulk density of aggregate is in the range of 1.5 to 2.3 g/cm³, it is made possible to efficiently produce the single crystal sapphire by heating the α-alumina in the crucible to melt it, followed by pulling up from the melt.

Therefore, the present invention can provide α-alumina which can allow the single crystal sapphire to be efficiently produced.

### DETAILED DESCRIPTION OF THE PREFERRED EMBODIMENTS

The α-alumina for producing single crystal sapphire according to the present invention is characterized in that its volume per one α-alumina particle is not less than 0.01 cm³, and its relative density is not less than 80%, and its bulk density of aggregate is in the range of 1.5 to 2.3 g/cm³. The α-alumina for producing single crystal sapphire can be prepared by for example shaping a mixture of an α-alumina precursor and α-alumina seed particles, and then calcinating the mixture.

The α-alumina precursor used in the above method is a compound which can be converted to α-alumina by calcination. Examples of such a compound include aluminum hydroxide; aluminum alkoxides, such as aluminum isopropoxide, aluminum ethoxide, aluminum sec-butoxide, and aluminum tert-butoxide; transition alumina, such as γ-alumina, δ-alumina, and θ-alumina; and the like. Usually, the aluminum hydroxide is used.

Aluminum hydroxide may be obtained by hydrolyzing a hydrolysable aluminum compound. Examples of the hydrolysable aluminum compound include aluminum alkoxides, and aluminum chloride. Among them, aluminum alkoxides are preferable from the viewpoint of purity.

The crystal form of aluminum hydroxide may be an amorphous structure or a gibbsite structure. Although it is not particularly limited, a boehmite crystal structure is preferable.

Hereinafter, an example of using the aluminum hydroxide as the α-alumina precursor will be explained.

The α-alumina seed particles used in the above method are obtained by milling high purity α-alumina particles having a purity of not less than 99.99% by weight, and have a median particle diameter of preferably from 0.1 to 1.0 μm, more preferably from 0.1 to 0.4 μm. It is difficult to provide α-alumina having the relative density and bulk density as defined by the present invention, if the α-alumina seed particles would have a particle diameter exceeding 1.0 μm. Furthermore, even if the α-alumina seed particles would be ground so that its dimension becomes less than 0.1 μm, more energy may be required for grinding in spite that the relative density and bulk density of the obtained α-alumina for producing single crystal sapphire may not be changed.

Examples of the method for milling the high purity α-alumina particles include a dry milling method comprising milling the high purity α-alumina in a dry state, and a wet milling method comprising milling the high purity α-alumina in a slurry state with a solvent added therein may be employed. Among them, the wet milling method is usually employed.

To wet mill the high purity α-alumina, a milling apparatus such as a ball mill, and a medium agitation mill may be used. Water is usually used as a solvent. A dispersant may be added to the medium for carrying out milling to improve dispersibility. The dispersant to be added is preferably a polymeric dispersant such as poly (ammonium acrylate), which can be decomposed and evaporated off by calcination, since less impurities are introduced into the resulting α-alumina for producing single crystal sapphire.

The milling apparatus is preferably an apparatus in which a surface which is to be brought into contact with α-alumina is made of a high purity α-alumina or a resin lining is carried out from a viewpoint of less contamination of the α-alumina seed particles obtained. In the case of milling using a medium agitation mill, a milling medium is preferably made of high purity α-alumina.

The amount of the α-alumina seed particles is generally from 0.1 to 10 parts by weight, preferably from 0.3 to 7 parts by weight, per 100 parts by weight of the α-alumina particles after calcination. If the amount of the α-alumina seed particles is less than 0.1 parts by weight, the α-alumina having the relative density and bulk density as defined by the present invention may not be obtained. If the amount of the α-alumina seed particles exceeds 10 parts by weight, the relative density and bulk density of the obtained α-alumina for producing single crystal sapphire may not be changed, and an advantage to be expected in response to the used amount of α-alumina seed particles may not obtained.

The α-alumina seed particles are usually mixed with aluminum hydroxide in the form of slurry obtained by the wet-milling. The amount of the slurry containing α-alumina seed particles is usually from 100 to 200 parts by weight, preferably from 120 to 160 parts by weight, in terms of water in the slurry, per 100 parts by weight of the aluminum hydroxide. If the amount of water exceeds 200 parts by weight, the mixture may form slurry and thus a large amount of energy may be unpreferably required for drying. If the amount of water is less than 100 parts by weight, the fluidity of the mixture may become so low that the α-alumina seed particles and aluminum hydroxide may be insufficiently mixed.

The α-alumina seed particles and aluminum hydroxide can be mixed with good dispersion by using a ball mill or a blending mixer or applying ultrasonic wave to the mixture. Preferably, a blade type mixer is used since it can mix materials with a shear force applied thereto, thus resulting in that the α-alumina seed particles and aluminum hydroxide can be more uniformly mixed.

Examples of shaping the mixture made by mixing the aluminum hydroxide and the α-alumina seed particles can include press molding, tabletting molding and extrusion molding. A produced compact usually has a cylindrical shape or bale-like shape, but can be formed into a spherical shape by for example Marumerizer or tumbling granulator. If the shape of produced compact is spherical shape, cylindrical shape, or bale-like shape, a good fluidity would be obtained. Therefore, it is made possible to make a crystal grow to occur without clogging within an apparatus even if it is used by continuously feeding the raw materials into the apparatus which can be maintained under a high temperature atmosphere. Accordingly, a production efficiency of the single crystal sapphire produced from the α-alumina can be improved.

As regards the compact dimension, a volume per one particle that has calcinated is not less than 0.01 cm³, preferrably in the range of 0.01 to 10 cm³, more preferrably in the range of 0.01 to 2 cm³. It is not preferred since if the volume per one particle that has calcinated is less than 0.01 cm³, it is more likely that the compacts are adhered with one another in drying step or calcinating step.

Water can be removed from the compact by drying it or can not be dried. The compact can be dried in an oven or in a high-frequency drier. A drying temperature is generally from 60° C. to 180° C.

The mixture comprising the aluminum hydroxide and the α-alumina seed particles is calcinated. The calcining temperature is usually from 1200 to 1450° C., preferably from 1250 to 1400° C. from a viewpoint of the easy production of the α-alumina having the purity, specific surface area, relative density and bulk density defined by the present invention. If the calcining temperature exceeds 1450° C., a contamination of the α-alumina with impurities from a calcination furnace can be easily caused. If the calcining temperature is lower than 1200° C., the aluminum hydroxide may be insufficiently converted to the α-structure, or the relative density tends to decrease in some cases.

The mixture is heated to said calcining temperature at a heating rate of for example from 30° C./hr to 500° C./hr. The calcining time may be a sufficient period of time for causing the sufficient alphatization of aluminum hydroxide. The time is usually from 30 minutes to 24 hours, preferably from 1 to 10 hours, although it varies with a ratio of aluminum hydroxide to the α-alumina seed particles, the type of the calcination furnace, the calcining temperature, the calcining atmosphere and the like.

The mixture is preferably calcined in an air or in an inert gas such as nitrogen gas or argon gas. Alternatively, the calcination may be carried out in a highly humid atmosphere with a high partial pressure of water vapor.

A commonly used calcination furnace such as a tubular electric furnace, a box type electric furnace, a tunnel furnace, a far-infrared furnace, a microwave heating furnace, a shaft furnace, a reverberatory furnace, a rotary kiln, and a roller hearth kiln may be used for calcination of the mixture. The mixture may be calcined in a batch process or a continuous process. The calcination may be carried out in a static state or in a fluidized state.

The α-alumina for producing single crystal sapphire according to the present invention can be produced by the calcination of the mixture. In the obtained α-alumina for producing single crystal sapphire, its volume per one α-alumina particle is not less than 0.01 cm³, and its relative density is not less than 80%, more preferrably not less than 85%, and its bulk density of aggregate is in the range of 1.5 to 2.3 g/cm³. When the relative density is not less than 80%, heat transfer efficiency in case of heating and melting the α-alumina in the crucible can be improved, and as a result, a production efficiency of the single crystal sapphire can be increased. When the bulk density of aggregate is in the range of 1.5 to 2.3 g/cm³, a volumetrical efficiency of the crucible can be increased, and as a result, a production efficiency of the single crystal sapphire can be increased.

The single crystal sapphire can be easily produced by heating α-alumina for producing single crystal sapphire to melt it, followed by cooling it to allow a single crystallization of the mixture to occur.

In the α-alumina for producing single crystal sapphire according to the present invention, its specific surface area is preferrably not more than 1 m²/g, more preferrably not more than 0.1 m²/g. Since the specific surface area is not more than 1 m²/g, the amount of water trapped on the α-alumina particle surfaces from the atmosphere is small. Therefore, when α-alumina is heated and melt, water hardly oxidizes the crucible, and as a result, voids formed in single crystal sapphire decrease.

It is preferably that the α-alumina for producing single crystal sapphire according to the present invention has a purity of not less than 99.99% and each contents of Si, Na, Ca, Fe, Cu and Mg is not more than 10 ppm. Use of the α-alumina for producing single crystal sapphire according to the present invention as raw materials of the alumina for producing single crystal sapphire can provide a high quality sapphire substrate having no coloration and less cracking.

The α-alumina of the present invention can be used as raw materials in a method for growing single crystal sapphire, such as an EFG method, a Czochralski method and Kyropulos method. Preferably, it can be used in the EFG method in which the raw materials are required to be continuously fed.

### EXAMPLES

Hereinafter, the present invention will be described more in detail by the following Examples. However, the scope of the present invention is not limited to these Examples in any way.

The evaluation methods used in the Examples are as follows:

### (1) Relative Density

A sintered density was measured by Archimedes method, and the relative density was calculated by using the measured value of the sintered density and the following equation.

Relative density (%)=Sintered density [g/cm³]/3.98 μg/cm³; theoretical sintered density of α-alumina]×100

### (2) Volume

The volume was calculated from the sintered density of the α-alumina for producing single crystal sapphire as measured by Archimedes method and weight per one α-alumina for producing single crystal sapphire by using the following equation.

Volume (cm³/one piece)=weight (g/one piece)/sintered density (g/cm³).

### (3) Density of Impurity, Purity

The contents of Si, Na, Mg, Cu, Fe and Ca were measured by a solid atomic emission spectrometry. A total amount (%) of weight of SiO₂, Na₂O, MgO, CuO, Fe₂O₃ and CaO included in the α-alumina for producing single crystal sapphire was calculated from the above measured results, and the purity was calculated by subtracting the above value from 100. The calculation equation is as follows:

Purity (%)=100−the total amount of weight of the impurity (%).

### (4) Bulk Density

The bulk density was calculated by pouring the sample in the cylinder having an inner diameter of 37 mm and a height of 185 mm followed by dividing the sample weight by the volume of measuring container.

### (5) Specific Surface Area

A specific surface area was measured by a nitrogen adsorption method using a BET specific surface area measurement apparatus (2300-PC-1A manufactured by Shimadzu Corporation).

### Example 1

High purity α-alumina (trade name: AKP-53 produced by Sumitomo Chemical Co., Ltd.) was used as α-alumina seed particles. Water was added to the α-alumina, and then the mixture was milled with a wet ball mill to prepare slurry of α-alumina seed particles which contained 20% by weight of the alumina seed particles. The alumina seed particles had an average particle diameter of 0.25 μm.

High purity aluminum hydroxide obtained by the hydrolysis of an aluminum alkoxide was used as the α-alumina precursor. The α-alumina seed particle slurry and the aluminum hydroxide were mixed by means of a blender type mixer having, on its inner surface, agitation blades with a multi-step cross-shaped decomposition structure being rotatable at a high speed. The amount of the α-alumina seed particles used in the mixing step was 2.3 parts by weight per 100 parts by weight of the α-alumina obtained after calcination. The amount of water was 149 parts by weight per 100 parts by weight of aluminum hydroxide. After the amount of water was set to be 192 parts by weight per 100 parts by weight of aluminum hydroxide, the slurry was shaped in the cylindrical shape measuring a diameter of 5 mm×a length of 5 mm by the extrusion molding. The α-alumina for producing single crystal sapphire was obtained by drying the mixture at 60° C. in an oven to evaporate water off followed by heating it at a heating rate of 100° C./hr and calcining at a temperature of 1350° C. for 4 hours.

The α-alumina had the relative density of 98%, the volume of 0.014 cm³, the bulk density of 2.3 g/cm³, the specific surface area of not more than 0.1 m²/g. The contents of Si, Na, Mg, Cu, Fe and Ca contained in the powder were 4 ppm, not more than 5 ppm, not more than 1 ppm, not more than 1 ppm, 9 ppm, and not more than 1 ppm, respectively, and the alumina purity was 99.99%.

### Example 2

The α-alumina for producing single crystal sapphire was obtained by preparing in the same way as that of Example 1 with the exception of the fact that the mixture of aluminum hydroxide and α-alumina seed particles are shaped in the cylindrical shape measuring a diameter of 20 mm×a length of 40 mm by the extrusion molding.

The α-alumina had the relative density of 94%, the volume of 1.1 cm³, the bulk density of 1.8 g/cm³, the specific surface area of not more than 0.1 m²/g. The contents of Si, Na, Mg, Cu, Fe and Ca contained in the powder were 4 ppm, not more than 5 ppm, not more than 1 ppm, not more than 1 ppm, 5 ppm, and not more than 1 ppm, respectively, and the alumina purity was 99.99%.

### Comparative Example 1

AKQ-10 produced by Sumitomo Chemical Co., Ltd. had the relative density of 49%, the volume of 0.004 cm³, the bulk density of 1.2 g/cm³, the specific surface area of 2.8 m²/g. The contents of Si, Na, Mg, Cu, Fe and Ca contained in the powder were 6 ppm, not more than 5 ppm, 1 ppm, not more than 1 ppm, 5 ppm, and not more than 1 ppm, respectively, and the alumina purity was 99.99%.

Use of α-alumina of Examples 1, 2 provides improved heat transfer efficiency obtained in case of heating and melting in the crucible by for example EFG method, an increased volumetrical efficiency of the crucible, and an increased production efficiency of the single crystal sapphire.

1. An α-alumina for producing single crystal sapphire, wherein its volume per one α-alumina particle is not less than 0.01 cm³, and its relative density is not less than 80%, and its bulk density of aggregate is in a range of 1.5 to 2.3 g/cm³.

2. The α-alumina for producing single crystal sapphire according to claim 1, wherein its shape is any one of spherical shape, cylindrical shape, and bale-like shape.

3. The α-alumina for producing single crystal sapphire according to claim 1, wherein its specific surface area is not more than 1 m²/g.

4. The α-alumina for producing single crystal sapphire according to claim 1, wherein its purity is not less than 99.99% by weight, and the contents of Si, Na, Ca, Fe, Cu and Mg are not more than 10 ppm, respectively.
